(19) United States
(12) Patent Application Publication
(10) Pub. No.: US 2022/0398228 A1
(43) Pub. Date: Dec. 15, 2022

(54) IMPLEMENTING TENANCY ISOLATION FOR ENTITIES

(71) Applicant: SAP SE, Walldorf (DE)

(72) Inventors: Wei Chen, Shanghai (CN); Wei Zhao, Shanghai (CN); Queming Yang, Shanghai (CN)

(21) Appl. No.: 17/344,532

(22) Filed: Jun. 10, 2021

(51) Int. Cl. G06F 16/21; G06F 21/62; G06F 16/28; G06F 8/41

(52) U.S. Cl. CPC G06F 16/213; G06F 21/6218; G06F 16/289; G06F 8/447

(57) ABSTRACT

Techniques for implementing tenancy isolation for entities are disclosed. In some embodiments, a computer system performs operations comprising: compiling a software project having one or more source code files, the source code file(s) comprising entity classes, each one of the entity classes having a corresponding entity class definition comprising a tenancy isolation annotation that is defined in a software library, the compiling of the software project comprising compiling the entity classes; and enhancing the compiled entity classes based on the entity class definitions of the compiled entity classes comprising the tenancy isolation annotation, the enhancing the compiled entity classes comprising adding a tenancy filter to the corresponding entity class definitions of the compiled entity classes, the tenancy filter being configured to apply tenancy isolation to entity instances of the compiled entity classes in a relational database.

### BACKGROUND

A multi-tenancy architecture is a software architecture in which a single instance of software runs on a server and serves multiple tenants. Systems designed in such manner are often referred to as being shared, rather than dedicated or isolated. A tenant is a group of users who share a common access with specific privileges to a software instance. With a multi-tenancy architecture, a software application is designed to provide every tenant a dedicated share of the instance, including its data. Current solutions for implementing tenancy isolation in a multi-tenancy architecture involve a user manually analyzing relationships among entities and adding annotations to every entity that the user wants to isolate from external tenants. This process is error-prone, inefficient, and lacks scalability, thereby negatively affecting the functioning of the underlying computer system. In addition to the issues discussed above, other technical problems may arise as well.

### BRIEF DESCRIPTION OF THE DRAWINGS

Some example embodiments of the present disclosure are illustrated by way of example and not limitation in the figures of the accompanying drawings, in which like reference numbers indicate similar elements.

FIG. 1 is an example network diagram illustrating a system.

FIG. 2 is a block diagram illustrating example enterprise applications and services in an enterprise application platform.

FIG. 3 is a block diagram illustrating an example tenancy isolation system.

FIG. 4 illustrates an example entity relationship diagram.

FIG. 5 is a flowchart illustrating an example method of implementing tenancy isolation for entities.

FIG. 6 is a flowchart illustrating an example method of enhancing compiled entity classes.

FIG. 7 is a block diagram of an example computer system on which methodologies described herein can be executed.

### DETAILED DESCRIPTION

Example methods and systems for implementing tenancy isolation for entities are disclosed. In the following description, for purposes of explanation, numerous specific details are set forth in order to provide a thorough understanding of example embodiments. It will be evident, however, to one skilled in the art that the present embodiments can be practiced without these specific details.

The implementation of the features disclosed herein involves a non-generic, unconventional, and non-routine operation or combination of operations. By applying one or more of the solutions disclosed herein, some technical effects of the system and method of the present disclosure are to provide a computer system that is specially-configured to implement tenancy isolation for entities. In some example embodiments, the computer system implements tenancy isolation for entities by enhancing compiled entity classes based on entity class definitions of the compiled entity classes comprising a tenancy isolation annotation that is defined in a software library. The computer system may enhance the compiled entity classes by adding a tenancy filter to the entity class definitions of the compiled entity classes, with the tenancy filter being configured to apply tenancy isolation to entity instances of the compiled entity classes in a relational database. As a result of using the tenancy isolation annotation technique disclosed herein, the inefficient and error-prone process of manually analyzing and annotating entities can be avoided, thereby improving efficiency, accuracy, and scalability, and thus improving the functioning of the underlying computer system. Other technical effects will be apparent from this disclosure as well.

The methods or embodiments disclosed herein may be implemented as a computer system having one or more modules (e.g., hardware modules or software modules). Such modules may be executed by one or more hardware processors of the computer system. In some example embodiments, a non-transitory machine-readable storage device can store a set of instructions that, when executed by at least one processor, causes the at least one processor to perform the operations and method steps discussed within the present disclosure.

The details of one or more variations of the subject matter described herein are set forth in the accompanying drawings and the description below. Other features and benefits of the subject matter described herein will be apparent from the description and drawings, and from the claims.

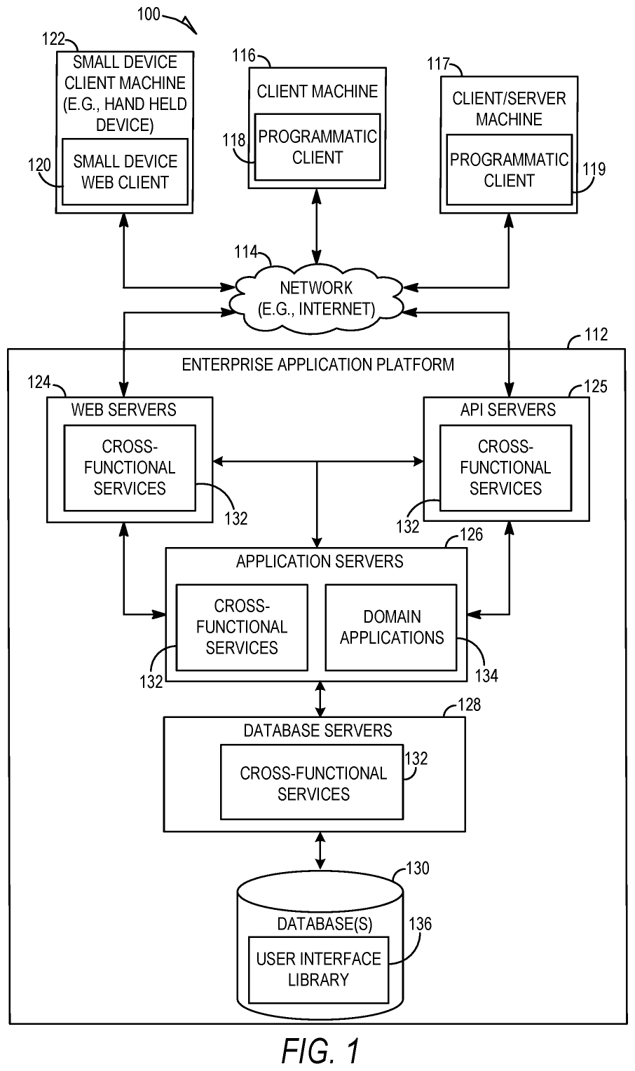

FIG. 1 is a network diagram illustrating a system 100, in accordance with some example embodiments. A platform (e.g., machines and software), in the example form of an enterprise application platform 112, provides server-side functionality, via a network 114 (e.g., the Internet) to one or more clients. FIG. 1 illustrates, for example, a client machine 116 with programmatic client 118 (e.g., a browser), a small device client machine 122 with a small device web client 120 (e.g., a browser without a script engine), and a client/server machine 117 with a programmatic client 119.

Turning specifically to the enterprise application platform 112, web servers 124 and Application Program Interface (API) servers 125 can be coupled to, and provide web and programmatic interfaces to, application servers 126. The application servers 126 can be, in turn, coupled to one or more database servers 128 that facilitate access to one or more databases 130. The web servers 124, API servers 125, application servers 126, and database servers 128 can host cross-functional services 132. The cross-functional services 132 can include relational database modules to provide support services for access to the database(s) 130, which includes a user interface library 136. The application servers 126 can further host domain applications 134. The web servers 124 and the API servers 125 may be combined.

The cross-functional services 132 provide services to users and processes that utilize the enterprise application platform 112. For instance, the cross-functional services 132 can provide portal services (e.g., web services), database services, and connectivity to the domain applications 134 for users that operate the client machine 116, the client/server machine 117, and the small device client machine 122. In addition, the cross-functional services 132 can provide an environment for delivering enhancements to existing applications and for integrating third-party and legacy applications with existing cross-functional services 132 and domain applications 134. In some example embodiments, the system 100 comprises a client-server system that employs a client-server architecture, as shown in FIG. 1. However, the embodiments of the present disclosure are, of course, not limited to a client-server architecture, and could equally well find application in a distributed, or peer-to-peer, architecture system.

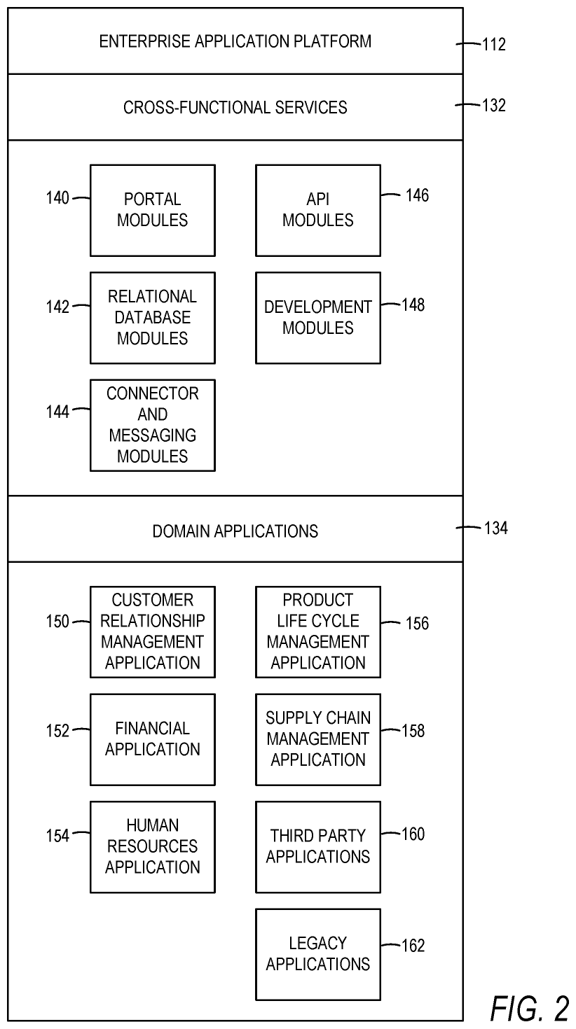

FIG. 2 is a block diagram illustrating enterprise applications and services in an enterprise application platform 112, in accordance with an example embodiment. The enterprise application platform 112 can include cross-functional services 132 and domain applications 134. The cross-functional services 132 can include portal modules 140, database modules 142 (e.g., relational database modules), connector and messaging modules 144, API modules 146, and development modules 148.

The portal modules 140 can enable a single point of access to other cross-functional services 132 and domain applications 134 for the client machine 116, the small device client machine 122, and the client/server machine 117. The portal modules 140 can be utilized to process, author and maintain web pages that present content (e.g., user interface elements and navigational controls) to the user. In addition, the portal modules 140 can enable user roles, a construct that associates a role with a specialized environment that is utilized by a user to execute tasks, utilize services, and exchange information with other users within a defined scope. For example, the role can determine the content that is available to the user and the activities that the user can perform. The portal modules 140 include a generation module, a communication module, a receiving module and a regenerating module. In addition, the portal modules 140 can comply with web services standards and/or utilize a variety of Internet technologies including JAVA®, J2EE, SAP's Advanced Business Application Programming Language (ABAP®) and Web Dynpro, XML, JCA, JAAS, X.509, LDAP, WSDL, WSRR, SOAP, UDDI and MICROSOFT® .NET®.

The database modules 142 can provide support services for access to the database(s) 130, which includes a user interface library 136. The database modules 142 can provide support for object relational mapping, database independence, and distributed computing. The database modules 142 can be utilized to add, delete, update, and manage database elements. In addition, the database modules 142 can comply with database standards and/or utilize a variety of database technologies including SQL, SQLDBC, Oracle, MySQL, Unicode, JDBC, or the like.

The connector and messaging modules 144 can enable communication across different types of messaging systems that are utilized by the cross-functional services 132 and the domain applications 134 by providing a common messaging application processing interface. The connector and messaging modules 144 can enable asynchronous communication on the enterprise application platform 112.

The API modules 146 can enable the development of service-based applications by exposing an interface to existing and new applications as services. Repositories can be included in the platform as a central place to find available services when building applications.

The development modules 148 can provide a development environment for the addition, integration, updating, and extension of software components on the enterprise application platform 112 without impacting existing cross-functional services 132 and domain applications 134.

Turning to the domain applications 134, a customer relationship management application 150 can enable access to and can facilitate collecting and storing of relevant personalized information from multiple data sources and business processes. Enterprise personnel that are tasked with developing a buyer into a long-term customer can utilize the customer relationship management applications 150 to provide assistance to the buyer throughout a customer engagement cycle.

Enterprise personnel can utilize financial applications 152 and business processes to track and control financial transactions within the enterprise application platform 112. The financial applications 152 can facilitate the execution of operational, analytical, and collaborative tasks that are associated with financial management. Specifically, the financial applications 152 can enable the performance of tasks related to financial accountability, planning, forecasting, and managing the cost of finance.

Human resource applications 154 can be utilized by enterprise personnel and business processes to manage, deploy, and track enterprise personnel. Specifically, the human resource applications 154 can enable the analysis of human resource issues and facilitate human resource decisions based on real-time information.

Product life cycle management applications 156 can enable the management of a product throughout the life cycle of the product. For example, the product life cycle management applications 156 can enable collaborative engineering, custom product development, project management, asset management, and quality management among business partners.

Supply chain management applications 158 can enable monitoring of performances that are observed in supply chains. The supply chain management applications 158 can facilitate adherence to production plans and on-time delivery of products and services.

Third-party applications 160, as well as legacy applications 162, can be integrated with domain applications 134 and utilize cross-functional services 132 on the enterprise application platform 112.

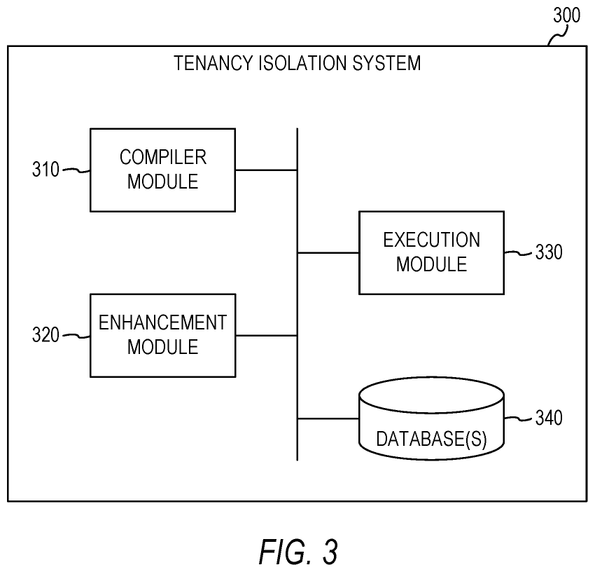

FIG. 3 is a block diagram illustrating an example tenancy isolation system 300. The tenancy isolation system 300 may be configured to implement tenancy isolation for entities. In some example embodiments, the tenancy isolation system 300 comprises any combination of one or more of a compiler module 310, an enhancement module 320, an execution module 330, and one or more database(s) 340. The compiler module 310, the enhancement module 320, the execution module 330, and the database(s) 340 can reside on a computer system, or other machine, having a memory and at least one processor (not shown).

In some example embodiments, one or more of the compiler module 310, the enhancement module 320, and the execution module 330 are configured to provide a variety of user interface functionality, such as generating user interfaces, interactively presenting user interfaces to the user, receiving information from the user (e.g., interactions with user interfaces), and so on. Presenting information to the user can include causing presentation of information to the user (e.g., communicating information to a device with instructions to present the information to the user). Information may be presented using a variety of means including visually displaying information and using other device outputs (e.g., audio, tactile, and so forth). Similarly, information may be received via a variety of means including alphanumeric input or other device input. In some example embodiments, one or more of the compiler module 310, the enhancement module 320, and the execution module 330 are configured to receive user input. For example, one or more of the compiler module 310, the enhancement module 320, and the execution module 330 can present one or more graphical user interface (GUI) elements (e.g., drop-down menu, selectable buttons, text field) with which a user can submit input. In some example embodiments, one or more of the compiler module 310, the enhancement module 320, and the execution module 330 are configured to perform various communication functions to facilitate the functionality described herein, such as by communicating with a computing device (e.g., the small device client machine 122, the client machine 116, or the client/server machine 117) via the network 114 using a wired or wireless connection.

In some embodiments, the compiler module 310, the enhancement module 320, the execution module 330, and the database(s) 340 are incorporated into the enterprise application platform 112 in FIGS. 1 and 2. However, it is contemplated that other configurations of the compiler module 310, the enhancement module 320, the execution module 330, and the database(s) 340 are also within the scope of the present disclosure.

In some example embodiments, the tenancy isolation system 300 is used to address technical problems that arise in implementing tenancy isolation for multi-tenancy architecture in Software-as-a-Service (SaaS) solutions. The tenancy isolation system 300 may implement tenancy isolation by partitioning the data for each tenant using a partition value or discriminator, which may be the tenant identifier when tenancy isolation is being implemented for a relational database.

Object-relational mapping tools, such as HIBERNATE®, may provide a framework for mapping an object-oriented domain model to a relational database, handling object-relational impedance mismatch problems by replacing direct, persistent database accesses with high-level object handling functions. Object-relational mapping tools are used to convert data between incompatible type systems using object-oriented programming languages, which may create, in effect, a virtual object database that can be used from within the programming language. In object-oriented programming, data-management tasks act on objects that are almost always non-scalar values. For example, an address book entry may represent a single person along with zero or more phone numbers and zero or more addresses, which may be modeled in an object-oriented implementation by a Person object with an attribute or field to hold each data item that the entry comprises: the person's name, a list of phone numbers, and a list of addresses. The list of phone numbers would itself contain Phone Number objects and possibly other objects. Each such address-book entry is treated as a single object by the programming language (it can be referenced by a single variable containing a pointer to the object, for instance). Various methods can be associated with the object, such as methods to return the preferred phone number, the home address, and so on.

By contrast, many popular database products, such as structured query language (SQL) database management systems (DBMS), are not object-oriented and can only store and manipulate scalar values, such as integers and strings organized within tables. The programmer must either convert the object values into groups of simpler values for storage in the database (and convert them back upon retrieval), or only use simple scalar values within the program. Object-relational mapping implements the first approach.

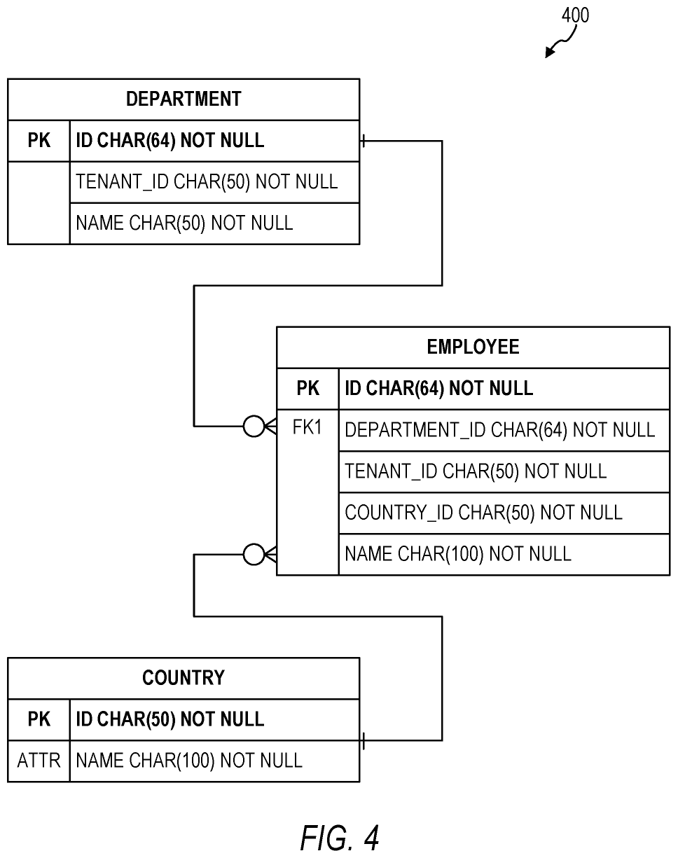

Currently, in order to achieve tenancy isolation by partition in the framework of object-relational mapping tools, a user needs to define filters everywhere the user wants to apply the tenancy isolation and annotate every entity or its fields with customized persister and entity listeners, which is inefficient and error-prone. For example, FIG. 4 illustrates an example entity relationship diagram 400. The example entity relationship diagram 400 shows three entity classes: department, employee, and country. The representations of these entity classes in JAVA® Persistence API (PA) is provided in the following table (Table 1).

| Entity | Tenant Aware | Definition |
|---|---|---|
| Employee | Yes (by | @Entity |
| | discriminator | public class Employee { |
| | Column | @Id |
| | ‘tenantID’) | @Column(name=″ID″) |
| | | private String ID; |
| | | @Column(name=″TENANT_ID″) |
| | | private String tenantID; |
| | | @Column(name=″USER_NAME″) |
| | | private String userName; |
| | | @ManyToOne |
| | | @JoinColumn(name = ″COUNTRY_ID″) |
| | | private Country country; |
| | | @ManyToOne |
| | | @JoinColumn(name = ″DEPARTMENT_ID″) |
| | | private Department department; |
| | | } |
| Department | Yes (by | @Entity |
| | discriminator | public class Department { |
| | Column | @Id |
| | ‘tenantID’) | @Column(name = ″ID″) |
| | | private String ID; |
| | | @Column(name = ″TENANT_ID″) |
| | | private String tenantID; |
| | | @Column(name = ″NAME″) |
| | | private String name; |
| | | @OneToMany(mappedBy = ″department″) |
| | | private List<Employee> employees; |
| | | } |
| Country | No, but has | @Entity |
| | association | public class Country { |
| | To tenant- | @Id |
| | aware | @GeneratedValue(generator = ″uuid″) |
| | Entity | @Column(name=″ID″) |
| | Employee | private String ID; |
| | | @Column(name=″NAME″) |
| | | private String name; |
| | | @OneToMany( |
| | | mappedBy = ″country″ |
| | | ) |
| | | Private List<Employee> employees |
| | | } |

In order to implement tenancy isolation for the entity classes of the example above in a relational database using current solutions, the user would need to manually add filters and filter definitions in the corresponding entity class definitions in the code, such as shown in the following table (Table 2) of enhanced definitions:

| Entity | Enhanced Definition |
|---|---|
| Employee | @Entity |
| | @FilterDefs({@FilterDef( |
| | name = ″tenantAwareFilter_TENANT_ID″, |
| | defaultCondition = ″TENANT_ID=:tenant_id″, |
| | parameters = {@ParamDef( |
| | name = ″tenant_id″, |
| | type = ″string″ |
| | )} |
| | )}) |
| | @Persister( |
| | impl = TenantAwareEntityPersister.class |
| | ) |
| | @Filters({@Filter( |
| | name = ″tenantAwareFilter_TENANT_ID″, |
| | condition = ″TENANT_ID=:tenant_id″ |
| | )}) |
| | @EntityListeners({TenantEntityListener.class}) |
| | public class Employee { |
| | @Id |
| | @Column(name=″ID″) |
| | private String ID; |
| | @Column(name=″TENANT_ID″) |
| | private String tenantID; |
| | @Column(name=″USER_NAME″) |
| | private String userName; |
| | @ManyToOne |
| | @Filter( |
| | name= ″tenantAwareFilter_TENANT_ID″) |
| | @JoinColumn(name= ″DEPARTMENT_ID″) |
| | private Department department; |
| | @ManyToOne |
| | @Filter( |
| | name= ″tenantAwareFilter_TENANT_ID″) |
| | @JoinColumn(name = ″COUNTRY_ID″) |
| | private Country country; |
| | } |
| Department | @Entity |
| | @Persister( |
| | impl = TenantAwareEntityPersister.class |
| | ) |
| | @Filters({@Filter( |
| | name = ″tenantAwareFilter_TENANT_ID″, |
| | condition = ″TENANT_ID=:immutable_tenant_id″ |
| | )}) |
| | @EntityListeners({TenantEntity Listener.class}) |
| | public class Department { |
| | @Id |
| | @Column(name = ″ID″) |
| | private String ID; |
| | @Column(name = ″TENANT_ID″) |
| | private String tenant_id; |
| | @Column(name = ″NAME″) |
| | private String name; |
| | @Filter( |
| | name= ″tenantAwareFilter_TENANT_ID″) |
| | @OneToMany(mappedBy = ″department″) |
| | @Persister( |
| | impl = TenantAwareOneToManyPersister.class |
| | ) |
| | private List<Employee> employees; |
| | } |
| Country | @Entity |
| | public class Country { |
| | @Id |
| | @GeneratedValue(generator = ″uuid″) |
| | @Column(name=″ID″) |
| | private String ID, |
| | @Column(name=″NAME″) |
| | private String name; |
| | @OneToMany( |
| | mappedBy = ″school″ } |
| | ) |
| | @Persister( |
| | impl = TenantAwareOneToManyPersister.class |
| | ) |
| | @Filters({@Filter( |
| | name = ″tenantAwareFilter_TENANT_ID″ |
| | )}) |
| | Private List<Employee> employees |
| | } |

As seen in the table above, current solutions for implementing tenancy isolation involves the user analyzing the relationships among entities and adding filters, listeners, and persisters. Given the massive number of entities that may managed in a relational database, this approach is inefficient and prone to error. The tenancy isolation system 300 may address these technical deficiencies by enabling the user to simply annotate the entity with a tenancy isolation annotation for any entity that the user wants managed in a tenant scope. The tenancy isolation system 300 may be configured to automatically analyze compiled classes and append annotations for implementing tenancy isolation, such as filters, filter definitions, entity listeners, and persisters, according to the relationship of the entities (e.g., by enhancing class bytecodes) in response to, or otherwise based on, the user adding the tenancy isolation annotation to the entity definition.

Filters restrict access to entity data by filtering data based on one or more conditions. An entity lister is an object which observes the lifecycle of entities. There are several lifecycle events defined in JPA: PrePersist, PostPersist, PostRemove, PreUpdate, PostUpdate, PostLoad. The listener can listen to these events, and get a chance to change data in the entity or interfere the process of the entities observed. A persister is an object that defines the contract describing mapping information and persistence logic for a particular strategy of entity mapping. In a JPA/Hibernate environment, a persister is used to load data from a database and populate entities, and is also able to save an entity's data to a database according to the ORM entity mapping specification.

One example of the tenancy isolation annotation is the annotation TenantAware, which may be defined as:

```
@Target({ElementType.TYPE})
public @interface TenantAware {
  /**
  *the property name of the entity which is used as the discriminator
  field.
  *@ return
  */
  String tenantField( );
}
```

Other types and forms of the tenancy isolation annotation are also within the scope of the present disclosure.

By implementing the functionality of the tenancy isolation annotation disclosed herein, the tenancy isolation system 300 improves the efficiency and reduces the risk of error in implementing tenancy isolation, such as by enabling the user to trigger the implementation of tenancy isolation for any entity simply by adding the tenancy isolation annotation to the entity, as shown in the example simplified definition of entities in the following table (Table 3):

| Entity | Tenant Aware | Definition |
|---|---|---|
| Employee | Yes (by | @Entity |
| | discriminator | @TenantAware |
| | Column | public class Employee { |
| | ‘tenantID’) | //the same as the content in Table 1 |
| | | } |
| Department | Yes (by | @Entity |
| | discriminator | @TenantAware |
| | Column | public class Department { |
| | ‘tenantID’) | //the same as the content in Table 1 |
| | | } |
| Country | No, but has | @Entity |
| | association | @TenantAware |
| | To tenant- | public class Country { |
| | aware | //the same as the content in Table 1 |
| | Entity | } |
| | Employee | |

Referring back to FIG. 3, in some example embodiments, the compiler module 310 is configured to compile a software project having one or more source code files. A software project may comprise programs, configuration definitions, and related data. The software project may be developed using object-oriented software programming (e.g., JAVA®), resulting in the creation of objects. A class is an extensible program-code-template for creating objects, providing initial values for state (member variables) and implementations of behavior (member functions or methods). In the relational model of database management, an object can be a table or column, or an association between data and a database entity. In some example embodiments, the one or more source code files of the software project comprise a plurality of entity classes. For example, the source code file(s) may comprise the entity classes (department, employee, country) shown in FIG. 4.

In some example embodiments, each one of the plurality of entity classes has a corresponding entity class definition that includes the tenancy isolation annotation, such as shown in Table 3 above in the example simplified definition of entities (e.g., @TenantAware). The tenancy isolation annotation may be defined in a software library. For example, the definition of the tenancy isolation annotation may be included in the software library, which may be stored in the database(s) 340. The definition of the tenancy isolation annotation may then be accessed by the execution module 330 during runtime of the software project.

In some example embodiments, the compiling of the software project comprises compiling the source code file(s) of the software project. Compiling the source code file(s) of the software project may comprise compiling the plurality of entity classes of the source code file(s). For example, the compiler module 310 may compile the entity class definitions in the example simplified definition of entities shown in Table 3 above. The compiled source code file(s) of the compiled software project may comprise bytecode. Bytecode is program code that has been compiled from source code into low-level code designed for a software interpreter. Bytecode may be executed by a virtual machine, such as by a JAVA® virtual machine (JVM), or further compiled into machine code, which is recognized by a processor.

In some example embodiments, the enhancement module 320 is configured to enhance the compiled entity classes based on the corresponding entity class definitions of the compiled plurality of entity classes comprising the tenancy isolation annotation. Examples of annotations and other code are provided below to facilitate describing features of the present disclosure. The examples discussed in the present disclosure use annotations and code that are consistent with the JPA specification. However, variations on these annotations and other code are also within the scope of the present disclosure. The term “tenant-aware entity” is used herein to refer to an entity for which a user wants to implement tenancy isolation and has annotated with the tenancy isolation annotation, such as by annotating the entity with the “@TenantAware” annotation.

In some example embodiments, the enhancement module 320 implements one or more of the following features in enhancing the compiled entity classes:
a tenant-aware entity defines a discriminator column and is specified by the attribute “tenantField” in the “@TenantAware” annotation;
if there is no @FilterDef defined in those entities, a new annotation @FilterDef with its attribute name is “tenantFilter_<discriminatorColumn>” and its condition equal to “<discriminatorColumn>=:tenantId” is created and appended to one of the tenant-aware entity classes. Here, the <discriminatorColumn> is the name of the column that the discriminator field map to, and “:tenantId” is the parameter which should be set in runtime;
for tenant-aware entities, append a tenant-aware filter to the corresponding entity classes with their names being “tenantFilter_<discriminatorColumn>”;
for tenant-aware entities, append an annotation “@Persister” with its implementation attribute “impl” equal to TenantAwareEntityPersister.class;
for any association field in all entities (both tenant-aware or non-tenant-aware), append a tenant-aware filter to it only if the associated entity is a tenant-aware entity; the name of the tenant-aware filter is equal to “tenantFilter_<discriminatorColumnOfAssociatedEntity>”; here, the “<discriminatorColumnOfAssociatedEntity>” is the name of the column that the discriminator field of the associated entity maps to;
for any one-to-many association field in all entities (both tenant-aware or non-tenant-aware), append an annotation “@Persister” with its implementation attribute “impl” equal to TenantWareOneToManyPersister only if the associated entity is a tenant-aware entity; and
for any association collection field of type other than one-to-many in all entities (both tenant-aware or non-tenant-aware), append an annotation “@Persister” with its implementation attribute “impl” equal to TenantWareCollectionfPersister only if the associated entity is a tenant-aware entity.
   Further details of how the enhancement module 320 implements the above-mentioned features will be discussed below with respect to examples of operations that may be performed by the enhancement module 320.

As will be discussed in further detail below, in some example embodiments, the enhancement module 320 is configured to: (a) collect metadata of the software project, (b) analyze the collected metadata, and (c) enhance the entity classes based on the analysis of the collected metadata. The metadata may be used as key information in determining which classes should be enhanced and how to enhance them in the entire process. One example of the structure of the metadata can be described in the following example pseudo code:

```
Def Structure ProjectMetadata {
    classMetadata : Map from className to ClassMetaData;
    filterDefinitions : List of FilterDefinition
filterDefnitionsToCIaim: List of FilterDefinition.
}
Def Structure ClassMetadata {
    existingFilterDefinitions : List of FilterDefinition;
    existingFliters : List of Filter
    existingEntityListeners : List of Class
    filterDefinitionsToClaim : List of FilterDefinition
    filtersToClaim : List ofFilterDefinitionIdentifier
    isTenantAwareEntityListenerDefined: Boolean
    customizedPersisterDefined: Boolean
    tenantAwareMetadata: {
        tenantWare: Boolean
    hasTenantAwareAssocation: Boolean
    tenantAwareField: string
    tenantDiscriminatorColomn: string
    }
    fieldsMetadata: Map of String to FieldMatadata
}
Def structure FieldMetaData : {
    existingFliters : List of Filter
filtersToClaim : List ofFilterDefinitionIdentifier
}
def structure FilterDefinition : {
    filterName : string
    filterParameters : List of Parameter
    filterCondition : Expression
    aliases : List of String
}
Def Parameter: {
    name: string
    type: string # primitive type only.
}
Def Expression : string
FilterDefinitionIdentifier : string
```

In some example embodiments, the collecting of the metadata is divided into three main sub-steps: (1.1) creating a metadata instances for the entity classes, (1.2) populating the metadata instances, and (1.3) defining claims for the entity classes. The enhancement module 320 may perform these three main sub-steps using the example operations, annotations, and identifiers below. Variations on the example operations, annotations, and identifiers below may also be used.

The enhancement module 320 may perform the following sub-operations in performing sub-step (1.1) creating the metadata instances for the entity classes:
1.1.1) Create a ProjectMetadata instance (also referred to as “PM”).
1.1.2) Visit all of the compiled entity classes in the software project.
1.1.3) For each entity class, create a ClassMetadata instance (also referred to as “CM”) and set its attributes according to step (1.2), an example of which will be discussed in further detail below. For other non-entity classes, discard them.
1.1.4) Put the CM in the PM.classMetadata map only if the class just visited is a tenant-aware entity or has association to any tenant-aware entity, such as by checking whether the Boolean value of CM.tenantAware or CM.hasTenantAwareAssocation is true.

The enhancement module 320 may perform the following sub-operations in performing sub-step (1.2) populating the metadata instances:
1.2.1) Load the bytecode of the class and visit its bytecode.
1.2.2) Check if the class is annotated with the annotation “@Entity”; if it is not, the sub-step (1.2) stops here; otherwise, continue to the next step.
1.2.3) Create an instance of ClassMetadata CM.
1.2.4) Collect all the Filter Definitions defined in the class level by checking all the annotations “@FilterDef”, and add them to CM.existingFilterDefinitions.
1.2.5) Collect all the filters defined in the class level by checking all the annotations “@Filter”, and add them to CM.existingFilters.
1.2.6) Collect all the EntityListener defined in the class level by checking all the annotations “@EntityListener”, and add them to CM.existingEntityListeners.
1.2.7) Make CM.customizedPersisterDefined true if the class is annotated by “@Persister”.
1.2.8) Instantiate CM.tenantAwareMetadata (also referred to as “CTAM”); if the entity class is annotated by the annotation “@TenantAware”, then make CTAM.tenantAware=true and make the CTAM.tenantField equal to the field specified by the attribute “tenantField” of the annotation @TenantAware; else, make it false.
1.2.9) Visit every field in the class according to step (1.3), an example of which will be discussed in further detail below.

The enhancement module 320 may perform the following sub-operations in performing sub-step (1.3) defining claims for the entity classes.
1.3.1) Check if the field of an entity class is an association by checking if there are any of the following annotations “@OneToOne, @OneToMany, @ManyToOne” are declared; if it is, then go to the next step; else, go to step 1.3.8.
1.3.2) Check if the associated entity is a tenant-aware entity; if it is, then continue to next step; else stop here.
1.3.3) Create an instance of type FieldMetadata (also referred to as “FM”) for this field and put in the map CM.fieldMadata.
1.3.4) Collect all the declared @Filter in the field and add them to FM.existingFilters.
1.3.5) Get the association entity class, and generate a filter claim accordingly; an example of how to generate the filter claim will be discussed in further detail below.
1.3.6) Check if there is an annotation “@Persister” defined for the field; if it is, then make FM.customizedPersisterDefined true; else make it false.
1.3.7) Mark CM.hasTenantAwareAssociation true if CM.tenantAware is false; then continue to step 1.3.9.
1.3.8) Check if the name of the field is the same as the name defined in CM.tenantAwareField; if it is, then make the CM.tenantColumn equal to the value of the attribute “name” specified by the “@Column” annotation.
1.3.9) Stop and visit next field.

In some example embodiments, the enhancement module 320 may generate a filter definition claim using the following techniques. The structure of a filter definition claim may be the same as the structure of a filter definition. Given a TenantAware entity, the name of the filter definition may be “tenantAwareFilter_<tenantDiscriminatorColumn>”, where the tenantDiscriminatorColumn is the name of the Column which is used to discriminate the tenant. The filterCondition may be “tenantAwareFilter_<tenantDiscriminatorColumn>=:tenant_id”, where the “:tenant_id” is a parameter that can be set in a session of an object-relational mapping tool (e.g., HIBERNATE®) at runtime. In one example, a TenantAware class may be as follows.

```
@Entity
    @TenantAware
    public class Employee {
    ...
    @Column(name=”TENANT_ID”)
    Private String tenantId;
    ...
    }
Given the example TenantAware class above, the enhancement
module 320 may generate the following filter definition claim:
    structure FilterDefinition : {
        filterName = “tenantAwareFilter_TENANT_ID”
        filterParameters: [
            tenant_id = string
        ]
        filterCondition : “TENANT_ID = :tenant_id”
        aliases: [ ]
      }
```

In some example embodiments, when a field is an association field to a tenant-aware entity, the enhancement module 320 may generate a filter claim for it. The filter claim may be the name of the filter definition the field required. For example, the name may be “tenantAware_<columnName>”, where <columnName> is the tenant discriminator column of the entity to which the field is associating.

In some example embodiments, the analyzing of the project metadata is divided into three main sub-steps: (2.1) merging all of the existing filter definitions, (2.2) removing duplicate filter definition claims, and (2.3) correcting the name of filter claims. The enhancement module 320 may perform these three main sub-steps using the example operations, annotations, and identifiers below. Variations on the example operations, annotations, and identifiers below may also be used.

The enhancement module 320 may perform sub-step (2.1) merging all of the existing filter definitions by iterating all the ClassMetadata's in the PM.classMatadata map. For each FilterDefinition in the list “existingFilterDefinitions.” of each ClassMeadata instance, the enhancement module 320 may add it to PM.filterDefinitions, which is the global list of FilterDefinition, if it is not in the list. In this example, when the FilterDefinition is not in the list, it means that there is no such FilterDefinition with the same name in the list.

When a filter is needed for an entity or a field, a filter claim and a corresponding FilterDefinition claim may be generated in pair. In some cases, a FilterDefinition with the same condition and parameters may be already defined in the entities. A filter claim references to the FilterDefinition claim, which is defined. But, the FilterDefinition claim should not be defined more than once. However, sometimes the same FilterDefinition claim is defined more than once. For example, filter A and filter B may use the same FilterDefinition. In this example, a claim for filter A may be generated along with a claim for the FilterDefinition, and then a claim for filter B may be generated along with a duplicate claim for the same FilterDefinition. In some cases, the enhancement module 320 has previously collected all the FilterDefinition claims without considering if some of them are duplicated. In a software project, all the FilterDefinition claims are the same if all the entities use the same tenant discriminator column. The enhancement module 320 may perform sub-step (2.2) removing duplicate filter using the following techniques. The enhancement module 320 may remove the duplicated claims to the same FilterDefinition, but add the names of the filter claims to the alias list of the FilterDefinition, and correct the name of the filter claims to the predefined FilterDefinition. There are two conditions that may be used for determining if two FilterDefinition are the same: the names of the FilterDefinitions are the same, or the condition expressions are the same. If two FilterDefinitions satisfy any of these two conditions, then the enhancement module 320 may determine that they are the same.

The enhancement module 320 may perform sub-step (2.3) correcting the name of the filter claims using the following techniques. After removing the duplicated FilterDefinition claims, the enhancement module 320 may correct the names of filter claims that refer to the FilterDefinition claims removed in the previous step. The enhancement module 320 may check if there is a FilterDefinition in the PM.filterDefinitions or PM.filterDefinitionClaims by checking if its filter name is the same as the name of the filter claim or if its aliases contain the name of the filter claim. If either of these conditions is satisfied, then the enhancement module 320 may correct the filter name to be the FilterDefinition's name.

In some example embodiments, the enhancing of the entity classes is divided into two main sub-steps: (3.1) enhancing the entity classes, and (3.2) enhancing the fields in the entity class. The enhancement module 320 may perform these two main sub-steps using the example operations, annotations, and identifiers below. Variations on the example operations, annotations, and identifiers below may also be used.

The enhancement module 320 may perform the following sub-operations in performing sub-step (3.1) enhancing the entity classes, for each ClassMetadata in the map defined in ProjectMetadata.classMetadata:
3.1.1) Check if the entity class is tenant-aware by checking the attribute ClassMetadata. tenantAwareMetadata.tenamAware; if it is tenant-aware, then continue to step 3.1.2; otherwise, go to step 3.2 to process the fields of the entity class.
3.1.2) Check if there is any FilterDefinition in the ClassMetadata.filterDefinitionsToClaim; if there is, then add the annotation “@FilterDef” for each of them in the entity class; check “add FilterDef” section.
3.1.3) Check if there is any filter in the ClassMetadata.filtersToClaim; if there is, then add the annotation “@Filter” for each of them in the entity class.
3.1.4) Check if the TenantAwareEntityListener is already in ClassMetadata. existingEntityListeners; if it is not, then add the annotation “@EntityListener” to the class.
3.1.5) Check if the original entity class already defined a Persister by checking whether ClassMetadata.customizedPersisterDefined is true; if it is not, then add a @Persister annotation to the class.

The enhancement module 320 may, in performing sub-step (3.2) enhancing fields in the entity classes, enhance the field for each FieldMatadata in ClassMetadatafieldsMetadata by adding a tenant-aware filter and a persister, such as by performing the following sub-operations:
3.2.1) Check if there is any Filter in the FieldMetadatafltersToClaim; if there is, then add the annotation “@Filter” for each of them for the field.
3.2.2) Check if the field has already defined a persister by checking whether FieldMetadata.cuistomizedPersisterDefined is true; if it is not, then add a @Persister annotation to the field.

The enhancement module 320 may use one or more of the sub-steps or sub-operations discussed above to enhance the compiled plurality of entity classes. Other ways of enhancing the compiled plurality of entity classes may also be employed.

In some example embodiments, the execution module 330 is configured to execute the compiled software project on a cloud computing architecture. For example, the execution module 330 may execute the compiled software project on the enterprise application platform 112 in FIGS. 1 and 2 as a Software-as-a-Service (SaaS) solution. However, the compiled software project may be executed on other types of computing architectures and in other forms as well. In executing the compiled software project, the execution module 330 may implement tenancy isolation for the entity instances of the compiled plurality of entity classes in the relational database using the tenancy filter of the compiled plurality of entity classes. The tenancy filter may enforce a requirement that only users having a tenant ID that corresponds to a tenant ID required by the tenancy filter are allowed access to the data of the entity classes in the relational database.

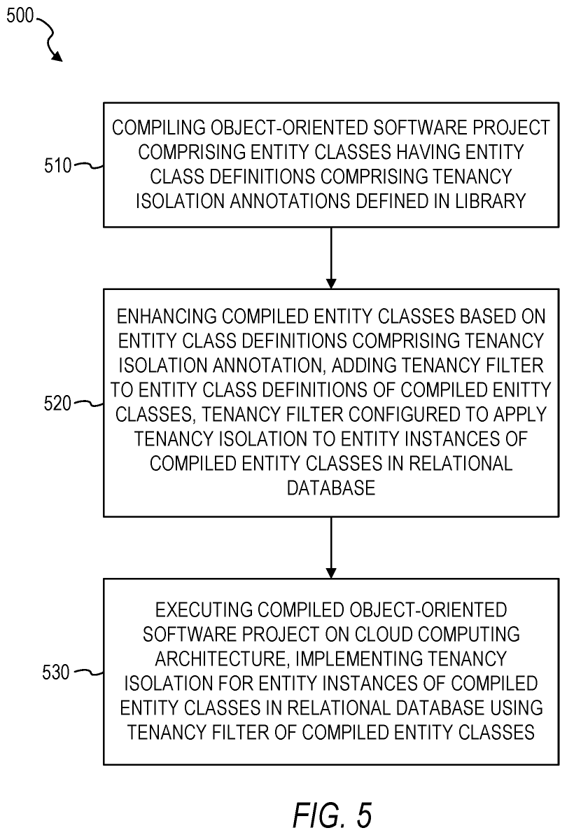

FIG. 5 is a flowchart illustrating an example method 500 of implementing tenancy isolation for entities. The method 500 can be performed by processing logic that can comprise hardware (e.g., circuitry, dedicated logic, programmable logic, microcode, etc.), software (e.g., instructions run on a processing device), or a combination thereof. In one example embodiment, one or more of the operations of the method 500 are performed by the tenancy isolation system 300 of FIG. 3 or any combination of one or more of its components (e.g., the compiler module 310, the enhancement module 320, the execution module 330).

At operation 510, the tenancy isolation system 300 compiles a software project having one or more source code files. The one or more source code files may comprise a plurality of entity classes, with each one of the plurality of entity classes having a corresponding entity class definition that comprises a tenancy isolation annotation, which may be defined in a software library. In some example embodiments, the compiling of the software project comprises compiling the plurality of entity classes.

Next, the tenancy isolation system 300 may enhance the compiled plurality of entity classes, at operation 520, based on the corresponding entity class definitions of the compiled plurality of entity classes comprising the tenancy isolation annotation. In some example embodiments, the enhancing the compiled plurality of entity classes comprises adding a tenancy filter to the corresponding entity class definitions of the compiled plurality of entity classes, with the tenancy filter being configured to apply tenancy isolation to entity instances of the compiled plurality of entity classes in a relational database. The compiled software project may comprise bytecode. However, the compiled software project may comprise other types of executable code, executable programs, or executable files as well.

The tenancy isolation system 300 may execute the compiled software project on a cloud computing architecture, at operation 530. The executing the compiled software project may comprise implementing tenancy isolation for the entity instances of the compiled plurality of entity classes in the relational database using the tenancy filter of the compiled plurality of entity classes. In some example embodiments, the compiled software project is deployed on the cloud computing architecture as a Software-as-a-Service (SaaS) solution. However, the compiled software project may be deployed in other ways as well.

It is contemplated that any of the other features described within the present disclosure can be incorporated into the method 500.

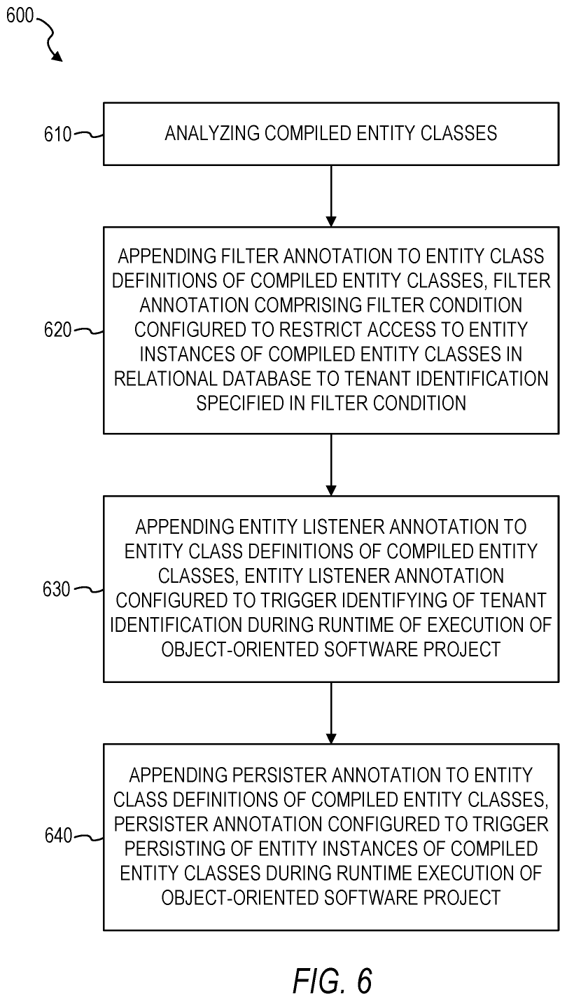

FIG. 6 is a flowchart illustrating an example method 600 of enhancing compiled entity classes. The method 600 can be performed by processing logic that can comprise hardware (e.g., circuitry, dedicated logic, programmable logic, microcode, etc.), software (e.g., instructions run on a processing device), or a combination thereof. In one example embodiment, one or more of the operations of the method 600 are performed by the tenancy isolation system 300 of FIG. 3 or any combination of one or more of its components (e.g., the enhancement module 320).

At operation 610, the tenancy isolation system 300 analyzes the compiled plurality of entity classes. For example, the tenancy isolation system 300 may perform one or more of the sub-steps 1.1-1.3 and 2.1-2.3 discussed above.

Next, the tenancy isolation system 300 may append a filter annotation to the corresponding entity class definitions of the compiled plurality of entity classes, at operation 620, based on the analyzing of the compiled plurality of entity classes. In some example embodiments, the filter annotation comprises a filter condition configured to restrict access to the entity instances of the compiled plurality of entity classes in the relational database to a tenant identification specified in the filter condition.

The tenancy isolation system 300 may also append an entity listener annotation to the corresponding entity class definitions of the compiled plurality of entity classes, at operation 630, based on the analyzing of the compiled plurality of entity classes. The entity listener annotation may be configured to trigger an identifying of the tenant identification during a runtime of an execution of the compiled software project.

Additionally, at operation 640, the tenancy isolation system 300 may append a persister annotation to the corresponding entity class definitions of the compiled plurality of entity classes based on the analyzing of the compiled plurality of entity classes. The persister annotation may be configured to trigger a persisting of the entity instances of the compiled plurality of entity classes during a runtime of an execution of the compiled software project.

The operations 620, 630, and 640 may be performed in any order with respect to one another. For example, the operations 620, 630, and 640 may be performed concurrently. Alternatively, the operation 620 may be performed prior to the operation 630, and the operation 630 may be performed before the operation 640. In another example, the operation 630 may be performed before the operation 620, and the operation 620 may be performed before the operation 640. Other configurations of the order in which the operations 620, 630, and 640 are performed are also within the scope of this present disclosure.

It is contemplated that any of the other features described within the present disclosure can be incorporated into the method 600.

In view of the disclosure above, various examples are set forth below. It should be noted that one or more features of an example, taken in isolation or combination, should be considered within the disclosure of this application.

Example 1 includes a computer-implemented method performed by a computer system having a memory and at least one hardware processor, the computer-implemented method comprising: compiling a software project having one or more source code files, the one or more source code files comprising a plurality of entity classes, each one of the plurality of entity classes having a corresponding entity class definition comprising a tenancy isolation annotation that is defined in a software library, the compiling of the software project comprising compiling the plurality of entity classes; and enhancing the compiled plurality of entity classes based on the corresponding entity class definitions of the compiled plurality of entity classes comprising the tenancy isolation annotation, the enhancing the compiled plurality of entity classes comprising adding a tenancy filter to the corresponding entity class definitions of the compiled plurality of entity classes, the tenancy filter being configured to apply tenancy isolation to entity instances of the compiled plurality of entity classes in a relational database.

Example 2 includes the computer-implemented method of example 1, wherein the enhancing the compiled plurality of entity classes comprises: analyzing the compiled plurality of entity classes; and appending a filter annotation to the corresponding entity class definitions of the compiled plurality of entity classes based on the analyzing the compiled plurality of entity classes, the filter annotation comprising a filter condition configured to restrict access to the entity instances of the compiled plurality of entity classes in the relational database to a tenant identification specified in the filter condition.

Example 3 includes the computer-implemented method of example 1 or example 2, wherein the enhancing the compiled plurality of entity classes further comprises: appending an entity listener annotation to the corresponding entity class definitions of the compiled plurality of entity classes based on the analyzing the compiled plurality of entity classes, the entity listener annotation being configured to trigger an identifying of the tenant identification during a runtime of an execution of the compiled software project.

Example 4 includes the computer-implemented method of any one of examples 1 to 3, wherein the enhancing the compiled plurality of entity classes further comprises: appending a persister annotation to the corresponding entity class definitions of the compiled plurality of entity classes based on the analyzing the compiled plurality of entity classes, the persister annotation being configured to trigger a persisting of the entity instances of the compiled plurality of entity classes during a runtime of an execution of the compiled software project.

Example 5 includes the computer-implemented method of any one of examples 1 to 4, further comprising: executing the compiled software project on a cloud computing architecture, the executing the compiled software project comprising implementing tenancy isolation for the entity instances of the compiled plurality of entity classes in the relational database using the tenancy filter of the compiled plurality of entity classes.

Example 6 includes the computer-implemented method of any one of examples 1 to 5, wherein the compiled software project is deployed on the cloud computing architecture as a Software-as-a-Service (SaaS) solution.

Example 7 includes the computer-implemented method of any one of examples 1 to 6, wherein the compiled software project comprises bytecode.

Example 8 includes a system comprising: at least one processor; and a non-transitory computer-readable medium storing executable instructions that, when executed, cause the at least one processor to perform the method of any one of examples 1 to 7.

Example 9 includes a non-transitory machine-readable storage medium, tangibly embodying a set of instructions that, when executed by at least one processor, causes the at least one processor to perform the method of any one of examples 1 to 7.

Example 10 includes a machine-readable medium carrying a set of instructions that, when executed by at least one processor, causes the at least one processor to carry out the method of any one of examples 1 to 7.

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client, or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses that connect the hardware modules). In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the network 114 of FIG. 1) and via one or more appropriate interfaces (e.g., APIs).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry (e.g., a FPGA or an ASIC).

A computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

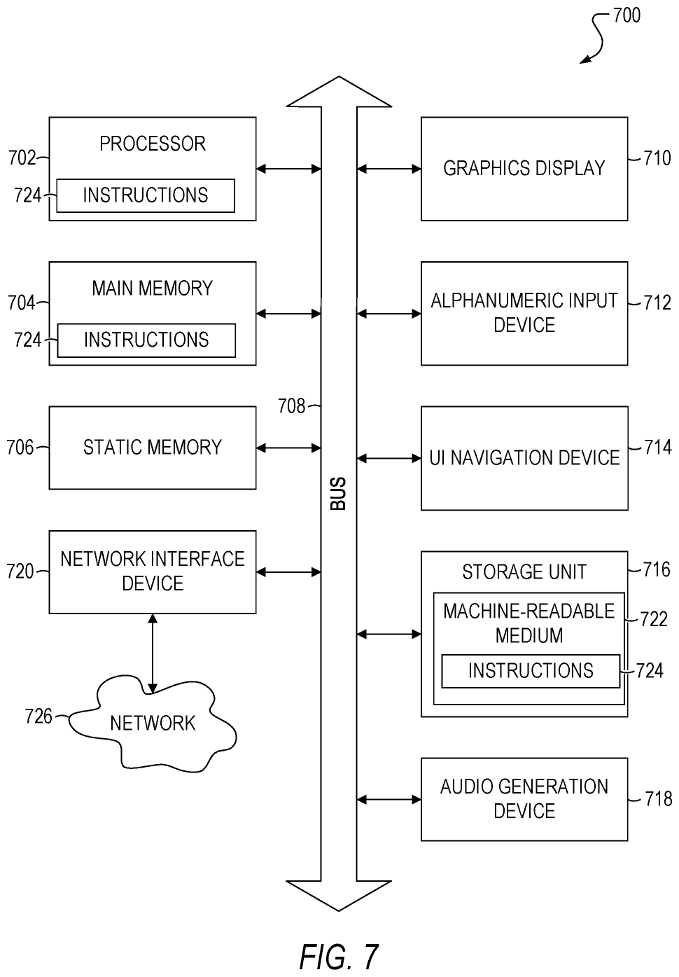

FIG. 7 is a block diagram of a machine in the example form of a computer system 700 within which instructions 724 for causing the machine to perform any one or more of the methodologies discussed herein may be executed. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 700 includes a processor 702 (e.g., a central processing unit (CPU), a graphics processing unit (GPU) or both), a main memory 704, and a static memory 706, which communicate with each other via a bus 708. The computer system 700 may further include a graphics or video display unit 710 (e.g., a liquid crystal display (LCD) or a cathode ray tube (CRT)). The computer system 700 also includes an alphanumeric input device 712 (e.g., a keyboard), a user interface (UI) navigation (or cursor control) device 714 (e.g., a mouse), a storage unit (e.g., a disk drive unit) 716, an audio or signal generation device 718 (e.g., a speaker), and a network interface device 720.

The storage unit 716 includes a machine-readable medium 722 on which is stored one or more sets of data structures and instructions 724 (e.g., software) embodying or utilized by any one or more of the methodologies or functions described herein. The instructions 724 may also reside, completely or at least partially, within the main memory 704 and/or within the processor 702 during execution thereof by the computer system 700, the main memory 704 and the processor 702 also constituting machine-readable media. The instructions 724 may also reside, completely or at least partially, within the static memory 706.

While the machine-readable medium 722 is shown in an example embodiment to be a single medium, the term “machine-readable medium” may include a single medium or multiple media (e.g., a centralized or distributed database, and/or associated caches and servers) that store the one or more instructions 724 or data structures. The term “machine-readable medium” shall also be taken to include any tangible medium that is capable of storing, encoding or carrying instructions for execution by the machine and that cause the machine to perform any one or more of the methodologies of the present embodiments, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices (e.g., Erasable Programmable Read-Only Memory (EPROM), Electrically Erasable Programmable Read-Only Memory (EEPROM), and flash memory devices); magnetic disks such as internal hard disks and removable disks; magneto-optical disks; and compact disc-read-only memory (CD-ROM) and digital versatile disc (or digital video disc) read-only memory (DVD-ROM) disks.

The instructions 724 may further be transmitted or received over a communications network 726 using a transmission medium. The instructions 724 may be transmitted using the network interface device 720 and any one of a number of well-known transfer protocols (e.g., HTTP). Examples of communication networks include a LAN, a WAN, the Internet, mobile telephone networks, POTS networks, and wireless data networks (e.g., WiFi and WiMAX networks). The term “transmission medium” shall be taken to include any intangible medium capable of storing, encoding, or carrying instructions for execution by the machine, and includes digital or analog communications signals or other intangible media to facilitate communication of such software.

Each of the features and teachings disclosed herein can be utilized separately or in conjunction with other features and teachings to provide a system and method for blind spot implementation in neural networks. Representative examples utilizing many of these additional features and teachings, both separately and in combination, are described in further detail with reference to the attached figures. This detailed description is merely intended to teach a person of skill in the art further details for practicing certain aspects of the present teachings and is not intended to limit the scope of the claims. Therefore, combinations of features disclosed above in the detailed description may not be necessary to practice the teachings in the broadest sense, and are instead taught merely to describe particularly representative examples of the present teachings.

Some portions of the detailed descriptions herein are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the below discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present disclosure also relates to an apparatus for performing the operations herein. This apparatus may be specially constructed for the required purposes, or it may include a general purpose computer selectively activated or reconfigured by a computer program stored in the computer. Such a computer program may be stored in a computer readable storage medium, such as, but not limited to, any type of disk, including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, and each coupled to a computer system bus.

The example methods or algorithms presented herein are not inherently related to any particular computer or other apparatus. Various general purpose systems, computer servers, or personal computers may be used with programs in accordance with the teachings herein, or it may prove convenient to construct a more specialized apparatus to perform the method steps disclosed herein. The structure for a variety of these systems will appear from the description herein. It will be appreciated that a variety of programming languages may be used to implement the teachings of the disclosure as described herein.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to aid in understanding how the present teachings are practiced, but not intended to limit the dimensions and the shapes shown in the examples.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A computer-implemented method performed by a computer system having a memory and at least one hardware processor, the computer-implemented method comprising:
compiling a software project having one or more source code files, the one or more source code files comprising a plurality of entity classes, each one of the plurality of entity classes having a corresponding entity class definition comprising a tenancy isolation annotation that is defined in a software library, the compiling of the software project comprising compiling the plurality of entity classes; and
enhancing the compiled plurality of entity classes based on the corresponding entity class definitions of the compiled plurality of entity classes comprising the tenancy isolation annotation, the enhancing the compiled plurality of entity classes comprising adding a tenancy filter to the corresponding entity class definitions of the compiled plurality of entity classes, the tenancy filter being configured to apply tenancy isolation to entity instances of the compiled plurality of entity classes in a relational database.

2. The computer-implemented method of claim 1, wherein the enhancing the compiled plurality of entity classes comprises:
analyzing the compiled plurality of entity classes; and
appending a filter annotation to the corresponding entity class definitions of the compiled plurality of entity classes based on the analyzing the compiled plurality of entity classes, the filter annotation comprising a filter condition configured to restrict access to the entity instances of the compiled plurality of entity classes in the relational database to a tenant identification specified in the filter condition.

3. The computer-implemented method of claim 2, wherein the enhancing the compiled plurality of entity classes further comprises:
appending an entity listener annotation to the corresponding entity class definitions of the compiled plurality of entity classes based on the analyzing the compiled plurality of entity classes, the entity listener annotation being configured to trigger an identifying of the tenant identification during a runtime of an execution of the compiled software project.

4. The computer-implemented method of claim 2, wherein the enhancing the compiled plurality of entity classes further comprises:
appending a persister annotation to the corresponding entity class definitions of the compiled plurality of entity classes based on the analyzing the compiled plurality of entity classes, the persister annotation being configured to trigger a persisting of the entity instances of the compiled plurality of entity classes during a runtime of an execution of the compiled software project.

5. The computer-implemented method of claim 1, further comprising:
executing the compiled software project on a cloud computing architecture, the executing the compiled software project comprising implementing tenancy isolation for the entity instances of the compiled plurality of entity classes in the relational database using the tenancy filter of the compiled plurality of entity classes.

6. The computer-implemented method of claim 5, wherein the compiled software project is deployed on the cloud computing architecture as a Software-as-a-Service (SaaS) solution.

7. The computer-implemented method of claim 1, wherein the compiled software project comprises bytecode.

8. A system of comprising:
at least one hardware processor; and
a non-transitory computer-readable medium storing executable instructions that, when executed, cause the at least one processor to perform operations comprising:
compiling a software project having one or more source code files, the one or more source code files comprising a plurality of entity classes, each one of the plurality of entity classes having a corresponding entity class definition comprising a tenancy isolation annotation that is defined in a software library, the compiling of the software project comprising compiling the plurality of entity classes; and
enhancing the compiled plurality of entity classes based on the corresponding entity class definitions of the compiled plurality of entity classes comprising the tenancy isolation annotation, the enhancing the compiled plurality of entity classes comprising adding a tenancy filter to the corresponding entity class definitions of the compiled plurality of entity classes, the tenancy filter being configured to apply tenancy isolation to entity instances of the compiled plurality of entity classes in a relational database.

9. The system of claim 8, wherein the enhancing the compiled plurality of entity classes comprises:
analyzing the compiled plurality of entity classes; and
appending a filter annotation to the corresponding entity class definitions of the compiled plurality of entity classes based on the analyzing the compiled plurality of entity classes, the filter annotation comprising a filter condition configured to restrict access to the entity instances of the compiled plurality of entity classes in the relational database to a tenant identification specified in the filter condition.

10. The system of claim 9, wherein the enhancing the compiled plurality of entity classes further comprises:
appending an entity listener annotation to the corresponding entity class definitions of the compiled plurality of entity classes based on the analyzing the compiled plurality of entity classes, the entity listener annotation being configured to trigger an identifying of the tenant identification during a runtime of an execution of the compiled software project.

11. The system of claim 9, wherein the enhancing the compiled plurality of entity classes further comprises:
appending a persister annotation to the corresponding entity class definitions of the compiled plurality of entity classes based on the analyzing the compiled plurality of entity classes, the persister annotation being configured to trigger a persisting of the entity instances of the compiled plurality of entity classes during a runtime of an execution of the compiled software project.

12. The system of claim 8, wherein the operations further comprise:
executing the compiled software project on a cloud computing architecture, the executing the compiled software project comprising implementing tenancy isolation for the entity instances of the compiled plurality of entity classes in the relational database using the tenancy filter of the compiled plurality of entity classes.

13. The system of claim 12, wherein the compiled software project is deployed on the cloud computing architecture as a Software-as-a-Service (SaaS) solution.

14. The system of claim 8, wherein the compiled software project comprises bytecode.

15. A non-transitory machine-readable storage medium tangibly embodying a set of instructions that, when executed by at least one hardware processor, causes the at least one processor to perform operations comprising:
compiling a software project having one or more source code files, the one or more source code files comprising a plurality of entity classes, each one of the plurality of entity classes having a corresponding entity class definition comprising a tenancy isolation annotation that is defined in a software library, the compiling of the software project comprising compiling the plurality of entity classes; and
enhancing the compiled plurality of entity classes based on the corresponding entity class definitions of the compiled plurality of entity classes comprising the tenancy isolation annotation, the enhancing the compiled plurality of entity classes comprising adding a tenancy filter to the corresponding entity class definitions of the compiled plurality of entity classes, the tenancy filter being configured to apply tenancy isolation to entity instances of the compiled plurality of entity classes in a relational database.

16. The non-transitory machine-readable storage medium of claim 15, wherein the enhancing the compiled plurality of entity classes comprises:
analyzing the compiled plurality of entity classes; and
appending a filter annotation to the corresponding entity class definitions of the compiled plurality of entity classes based on the analyzing the compiled plurality of entity classes, the filter annotation comprising a filter condition configured to restrict access to the entity instances of the compiled plurality of entity classes in the relational database to a tenant identification specified in the filter condition.

17. The non-transitory machine-readable storage medium of claim 16, wherein the enhancing the compiled plurality of entity classes further comprises:
appending an entity listener annotation to the corresponding entity class definitions of the compiled plurality of entity classes based on the analyzing the compiled plurality of entity classes, the entity listener annotation being configured to trigger an identifying of the tenant identification during a runtime of an execution of the compiled software project.

18. The non-transitory machine-readable storage medium of claim 16, wherein the enhancing the compiled plurality of entity classes further comprises:
appending a persister annotation to the corresponding entity class definitions of the compiled plurality of entity classes based on the analyzing the compiled plurality of entity classes, the persister annotation being configured to trigger a persisting of the entity instances of the compiled plurality of entity classes during a runtime of an execution of the compiled software project.

19. The non-transitory machine-readable storage medium of claim 15, wherein the operations further comprise;
executing the compiled software project on a cloud computing architecture, the executing the compiled software project comprising implementing tenancy isolation for the entity instances of the compiled plurality of entity classes in the relational database using the tenancy filter of the compiled plurality of entity classes.

20. The non-transitory machine-readable storage medium of claim 19, wherein the compiled software project is deployed on the cloud computing architecture as a Software-as-a-Service (SaaS) solution.
